(19) United States
(12) Patent Application Publication
(10) Pub. No.: US 2009/0039004 A1
(43) Pub. Date: Feb. 12, 2009

(54) Automatic oil filtration and treatment with level control and system heating during filtration

(75) Inventor: William Andersen, Cartersville, GA (US)

Correspondence Address: WEISS & WEISS, Suite 251, 300 Old Country Road, Mineola, NY, 11501, US

(73) Assignee: Bill Andersen Consulting LLC

(21) Appl. No.: 12/221,871

(22) Filed: Aug. 6, 2008

Related U.S. Application Data
(60) Provisional application No. 60/963,768, filed on Aug. 7, 2007.

(51) Int. Cl. A47J 37/12; B01D 35/02

(52) U.S. Cl. 210/167.28; 99/330; 99/408

(57) ABSTRACT

A system and method for automatic oil filtration and treatment with an enclosed filter medium.

### FIELD OF THE INVENTION

The present invention relates to a system and method for automatic oil filtration and treatment with an enclosed filter medium.

### BACKGROUND

Commercial fryers are used in a variety of applications from restaurants to supermarket delis to cook various food products. Most of these fryers hold approximately 5-10 gallons of heated oil and cook products using a batch system. Products are cooked for a period of time and then removed from the fryer. Usage of the fryer will vary based on the demand for product. The cooking and heating processes continually impact the frying oil by breaking it down physically and chemically. High heat generated by either an electric or gas source along with particulate that comes off the product and becomes sediment degrades the oil. The degradation significantly affects the useful life of the oil. Most all of the fryers either have a built in filtration unit or are compatible with a potable filtration unit. The filtering systems available in the marketplace today remove oil from the fryer either by gravity or pump and pull the oil through a static filter. The filter is comprised of either paper or a mesh screen or a combination of the two. Most of these systems clean the oil on a periodic basis and require the fryer heating system to be shut down during filtration. Some systems are capable of filtering the oil on a continuous basis but the process can effect the oil temperature and as a result impact cook times and food safety.

The current market pressures and legislation that have been fueled by recent health studies proposing the linkage of many health issues and diseases to the presence of trans-fats has forced the frying community to search out oils that do not contain trans-fats. The most widely and economical oil used for frying is partially hydrogenated soybean oil. Partially hydrogenated soybean oil goes through a process that re-aligns the chemical structure of the oil allowing it to become more stable than soybean oil. This process helps to retard the degradation process caused by heating and cooking. The process of hydrogenation, however, produces trans-fats. Plain soybean oil is significantly less stable under frying conditions than partially hydrogenated soybean oil. Genetically modified oils and oil blends may be more stable than plain soybean oil but are often significantly more expensive than both plain and partially hydrogenated soybean oils.

The current filtration systems have been filtering fryers on a batch basis. However, the current filtration systems do not provide frequent enough filtration to keep plain soybean oil from deteriorating quicker than the partially hydrogenated oil. Also, these systems do not continue to heat the oil during the filter cycle. Continuous systems lack the ability to start and stop the filtering process automatically. Oxidation of the oil occurs when sediment is not removed from the fryer frequently. If sediment is not removed the oil breaks down showing signs of unacceptable product quality manifested through dark color, and off odor and taste. In addition to good filtration, additives and anti-oxidants can be added to the frying oil to help prolong the life of the oil. In most cases these additives and anti-oxidants help non hydrogenated oil attain some of the stability characteristics of the hydrogenation process without creating trans-fats.

U.S. Pat. No. 6,955,118 relates to a filter mounting system of a filter assembly for a fryer apparatus. The filter mounting system includes a slip fitting slidably receivable in a slip fitting receiver of a tank outlet port. A grasping member is functionally attached to the mounting system for removal of the filter assembly without the necessity of cooling the cooking oil contained in the fryer.

U.S. Pat. No. 6,890,428 relates to a fryer filtration arrangement which includes an oil drain pan and associated filter assembly. The filter assembly may be removably connected to the pan by a friction fit coupling arrangement. The fryer vat may be shaped such that the particulate matter settles therein along a substantially linear region and oil circulated during a filtration operation may flow along the substantially linear region to push the settled particulate matter to the pan and filter assembly.

U.S. Pat. No. 6,235,210 relates to a combination continuous and batch filtration system for a recirculating fryer where the continuous filter and batch filter assemblies are integrated into a single unit, utilizing a common pump. The outlets of the continuous filter and the batch filter are connected to a two-way valve, which is, in turn, connected to the inlet of the common pump. The valve allows an operator to selectively pump cooking fluid from either the continuous filter or the batch filter back into the dryer vat.

U.S. Pat. No. 6,095,037 relates to a convection fryer with continuous filtration. Heat exchange within the fryer tank is facilitated by a “U shaped burner tube and a burner system is provided to circulate in a spiral pathway products of combustion through the burner tube. An internal turbulator baffle is provided to both facilitate the spiral circulation through the tube and facilitate heat transfer from the combustion gases to burner tube walls. Products are expelled through a flue. The system further comprises filter bags for continuously filtering the oil which are disposed in a sump at the surface of the oil so that oil continually spills from the tank into the sump where it is filtered preferably by one or more bags of cloth material. The system provides a pump for recirculating the filtered oil to the tank.

U.S. Pat. No. 5,731,024 relates to a continuous filtering and treating device and method with external treating mechanism. The device comprises a filtering mechanism immersed in a fryer filled with cooking oil, a treating mechanism situated external to the tank, and a suction pump which draws cooking oil from the fryer through the filtering mechanism, through the treating mechanism, and pumps it back into the fryer. The filtering mechanism comprises a wire mesh envelope and at least one wire mesh filter screen for filtering the cooking oil, an insert is disposed within the wire mesh envelope, and a frame which holds the wire mesh envelope and the insert together. Treating material is disposed within the treating mechanism and comprises any material which upon contact with the cooking oil can extend the usable life of the cooking oil.

U.S. Pat. No. 5,404,799 relates to a continuous filtering fryer apparatus for continuous filtering of cooking oil while cooking, having a tank, an inlet port extending into the interior of the tank and an outlet port affixed to the tank in communication with an interior of the tank. A pump is connected to the end port and the outlet port to draw cooking oil from the tank and pass the cooking oil to the inlet port. Heating elements extend into the interior of the tank, and a filter plate is attached to the inlet port adjacent the bottom of the tank for removing particles from the cooking oil. The patent further describes a method for continuously filtering cooking oil while frying comprising circulation of cooking oil through a mesh screen and related piping, returning the cooking oil to the tank until an aggregation of particulate matter accumulates on the outside surface of the mesh screen and continually circulating the cooking oil during the fryer operation.

US Patent Publication No. 2005/0056157 relates to a filter system for a deep fat fryer. The fryer includes a moveable filter pan disposed below the cooking tank which is fed by gravity when the tank is drained through a downspout. An inline removable filter is provided in the oil return line, and the return line is slidable supported on the side of the filter pan so that it can rise and fall with the debris in the filter pan.

US Patent Publication Nos. 2003/0196940 and 2002/0092803 relate to a fryer filtration arrangement which includes an oil drain pan and associated filter assembly. The filter assembly may be removably connected to the pan. The fryer vat may be shaped such that particulate matter settles therein along a substantially linear region and oil circulated during a filtration operation may flow along the substantially linear region to push the settled particulate matter to the pan and filter assembly.

US Patent Publication No. 2002/0069767 relates to a deep fat fryer with continuous filtration. Heat exchange within the fryer tank is facilitated by a U-shaped burner tube, and a burner system circulates in a spiral pathway products of combustion through the burner tube. An internal turbulator baffle facilitates the spiral circulation through the tube and heat transfer from the combustion gases to the burner tube walls. The system has filter bags for continuously filtering the oil which is disposed in a sump at the surface of the oil so that the oil continually spills from the tank into the sump where it is filtered by one or more bags of cloth material. The system provides a pump for recirculating the filtered oil to the tank.

US Patent Publication No. 2006/0076281 relates to a device for continuously filtering deep fat fryer oil. The deep fat fryer comprises a vat containing a bath of heated oil. A built in device filters the oil and collects the oil contained in the vat. The device further pumps, filters and recirculates the oil to the vat. The filtering device comprises a filtering unit on the upper part of the vat.

US Patent Publication No. 2007/0062515 relates to a fryer filtration arrangement with boil-out bypass. The unit does not require boil-out fluid to pass through a pump.

US Patent Publication No. 2005/0072309 relates to a deep fat fryer cooking oil filtration arrangement. The fryer includes a fryer vat, a pan for receiving oil drained from the fryer vat, and a filter assembly within the pan for filtering oil. An oil drain path leads from an outlet opening of the fryer vat to the pan, and automated drain valve is located along the oil drain path. An oil return path leads from the pan back to the fryer vat. A pump delivers oil from the pan back along the oil return path to the fryer vat. A control unit controls the automated valve and the pump.

US Patent Publication No. 2002/0035931 relates to a system and process for continuously filtering shortening, oil, and the like. The system comprises a fryer and a shortening removal tap positioned on the side wall, a pump, and a filter. Shortening is removed from the fryer through the shortening removal tap. The shortening is then passed through the filter and returned to the fryer.

### SUMMARY OF THE INVENTION

The present invention is different from current filtration systems because it is capable of automatic filtration, on demand filtration, continuous oil level control, heating of the oil during the filtering cycle and oil treatment. In the automatic mode, the filter controls senses the oil temperature, heating element amperage, cooking timer, and an auxiliary contact from the fryer heating system and filters the oil automatically when the temperature of the fryer is stable and the set point has been satisfied for a brief period of time. Once triggered, the automatic controls start a pump allowing the hot oil to be pumped through stainless steel fine mesh screens with a paper and or cloth type filter medium.

The filters containers are either cylinders or square shaped and have locking caps on them to contain the oil within the system. They are located adjacent to the fryer and at approximately the same level as the fryer oil to allow the oil to maintain a level within normal operating limits both during product frying and filtering operations. The sediment is deposited on the filter medium within the tubes and can be cleaned by replacing the filter medium and washing the stainless steel inserts periodically. After passing through the filter medium, the oil is directed via a port in the rear of the fryer onto the bottom of the fryer to move any accumulated sediment toward the oil discharge area. If the oil temperature sensor in the fryer senses a high demand for heat, the filter shuts off the pump thus shutting off the filter system. The system can also be initiated by the operator after cooking a batch by pressing the manual cycle start button or by receiving a signal from the product cooking timer. The system has a built in timer that can be set for a certain period of time and then automatically shut off. The operator can also run the system continuously by placing the system in manual. In addition to the filtration cycle, there is an automated dosing pump in the return pipe that has the ability to inject additives or antioxidants into the oil stream. Since the automatic controls have a record of the amount of product that has been fried, the amount of oil additive or antioxidant can be metered in an exact amount required by the cooked product's consumption. This is critical to maintain the proper balance in the oil, since additives and antioxidants are consumed during the frying process. The filter is designed to be easily cleaned and can withstand a full water wash down as well as harsh cleaning chemicals used in the fryer during boil-out. The filter can either be mounted adjacent to the fryer or mounted remotely. The filter in certain configurations can also be used to filter multiple fryers either simultaneously or individually in sequence. The pump is mounted under each fryer and the same inputs are run to wherever the fryer filter is stationed. An output wire is run from the filter controls to the pump in order for the pump to stop and start as described previously. Supply and return pipe lines are also run from the fryers to the remote filter. All other operations perform in a like manner. The filter can be programmed to filter fryers based on the priorities set by the operator. The off, manual, and automatic functions perform as described previously. The filtration unit can also be configured in as a mobile unit. The pump is mounted under the filter canisters. The unit can be attached to the fryer via the fryer drain valve. The filter is capable of performing all other previously mentioned functions.

With regards to prior art filtration systems, existing filtration systems use either static or continuous filtration but they do not use a method of automatic filtration via controls that sense when the fryer is actually frying product or sitting idle. Additionally they do not have controls that use either a timed filtration cycle initiated by the operator or the product timer. All current systems use a static form of filter media but they do not allow the filtration system to operate as a part of normal fryer operations without operator intervention. Current systems do not have the ability to maintain a level in the fryer and normal heating of the oil during the filtration cycle. The majority of the current systems use an open loop system that uses gravity to feed a pan and then suck the oil through a filtering medium.

The filtration system of the present invention senses when the fryer is idle and not frying product, and then automatically commences filtration. Additionally, the filter controls also sense when the fryer begins to operate under load by sensing a falling temperature in the fryer well when product is added and automatically shuts off the filter making all the heat available in the fryers heating system available for cooking. The present invention also allows an operator to initiate a timed filtration cycle at the push of a button or the system can start a timed cycle by receiving an input signal from the product cook timer.

The filtration system design of the present invention also includes a system to maintain a consistent oil level within the fryer. The constant oil level, and closed loop system allows the filter to be cycled automatically, on demand, and allows for the fryers heating system to continue to operate during filtration. This feature allows the fryer to maintain temperatures at or close to temperature set point, and allows the fryer to be ready for frying operations immediately after the filter cycle is complete. The filter system of the present invention is positively pumping dirty cooking oil through the filter media rather than be sucked through a filter media in the open loop systems of the present inventions. In addition, the system has the ability to automatically dose additives and antioxidants into the fryer that have not been found in prior art. Since the controls of the present invention have a record of the amount of time that the fryer spent frying, versus sitting in a static maintain temperature set point mode, the controls are capable of dosing additives and antioxidants in exact proportion to the amount of product being cooked.

### BRIEF DESCRIPTION OF THE DRAWINGS

FIG. 1 shows a side view of a fryer with the filter assembly of the present invention adjacent to the fryer.

FIG. 2 shows a side view and cross sectional view of the device. The view details the flow of oil through the system, system motor/pump, filter enclosures, and filter medium. Additionally, the figure shows the filter controls and process inputs and outputs.

FIG. 3 shows a detailed view of how the filter cartridges and media are assembled. It also shows how the assembly fits into the outer housing.

FIG. 4 shows a detailed view of the oil flow through filtering media.

FIG. 5 shows the accumulation of sediment within the filter assembly.

FIG. 6 shows a side view of a fryer with the filter assembly of the present invention under the fryer. The removable crumb tray is visible under the front panel door of the fryer.

FIG. 7 shows a side view and cross sectional view of the device. The view details the belt drive motor, belt filter medium, scraper bar, and crumb tray.

FIG. 8 shows a side view of the present invention. In addition to the features listed above in FIG. 6, FIG. 7 shows the filter belt hold down assembly and outer pan.

FIG. 9 shows a top view of the present invention. This view details the sump configuration under the filter belt and shows the oil return line.

FIG. 10 shows the detail of how the filter belt attaches to the drive chain.

FIG. 11 shows the controls to include the inputs and outputs of the device.

### DETAILED DESCRIPTION

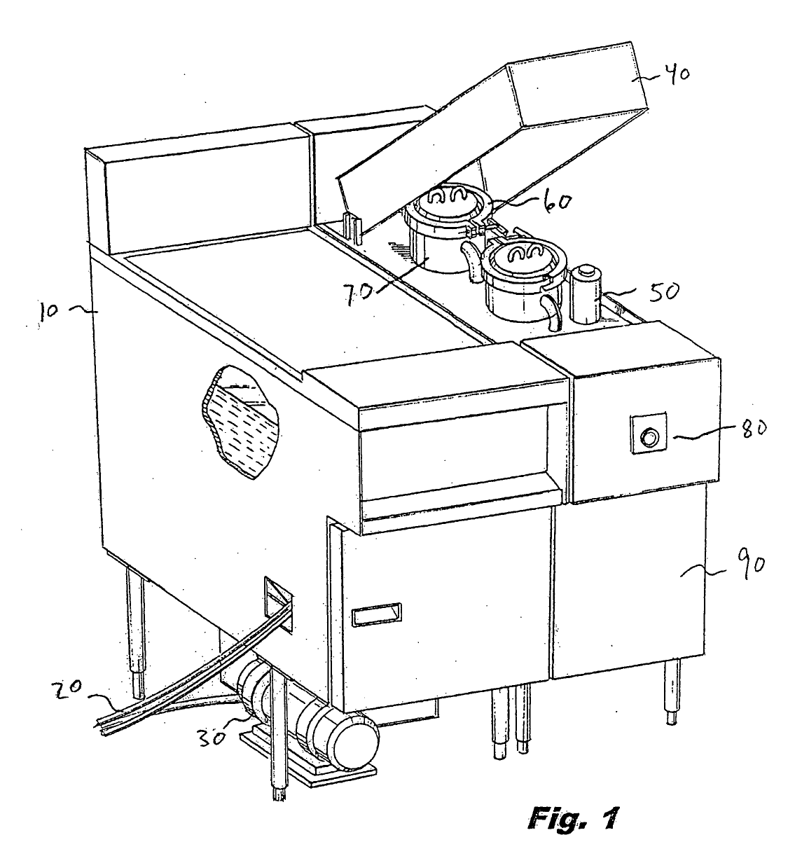

FIG. 1 shows the fryer 10 electrical cords 20 and filter assembly 90. The device is capable of operations using different standard voltages found in a restaurant or supermarket deli. The device can operate on 110V, 208V single phase, and 208V three phase. The device uses signals via the electrical cords 20 to operate a motor/pump assembly 30 to pump oil through closed loop filter canisters 70. The canisters have removable lids 60 that keep the system under pressure during pump operations. The lids 60 can be removed for easy cleaning of the filtering media within the filter canisters 70. A cycle start button 80 is shown that allows an operator to initiate a manual and on demand filtration cycle. In a preferred embodiment, the lid enclosure 40 engages the safety proximity switch 50 in order for the motor/pump assembly 30 to operate.

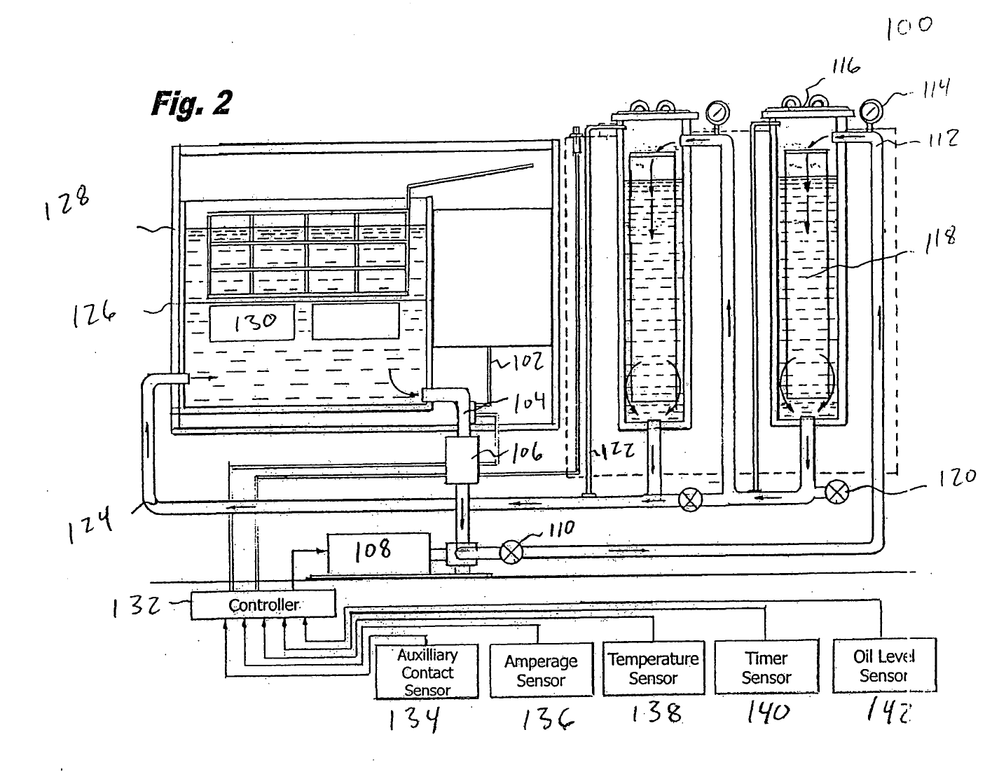

FIG. 2 shows the assembly 100 of the present invention and the flow of oil through the system. Oil that is contained in the fryer 126 feeds a motor/pump assembly 108 via piping 104 and a valve 106. The motor/pump assembly 108 pumps dirty oil into the filter cartridge assemblies 118 via the entry pipe 112. A pressure gauge 114 is used to show the back pressure on the filter cartridge assemblies 118 when in operation. The filter cartridge assemblies 118 are sealed by the removable caps 116. A self venting line 122 allows any air or steam to vent out of the system automatically. Oil flows back into the fryer via the oil return pipe 124. The figure further shows valves 110 and 120 used for draining the system. The thermocouple 102 is used as an input for the automatic controls. The oil level 128 is maintained because of the closed loop system 100 and the adjacent elevation and location of the filter cartridge assemblies 118. The closed loop system 100 and the constant oil level 128, allow the fryer heating elements 130 to heat the oil during the filtration cycle.

The filter controls 132 have an off, manual and automatic mode setting. The off mode shuts the unit completely off and the manual mode allows the operator to initiate continuous filtration or a timed cycle. After pressing the cycle start button 80 shown in FIG. 1, the motor/pump 108 will run for a pre-determined time and automatically shut off. In the automatic mode, the filter controller 132 receives inputs from filter sensors 134, 136, 138, 140 and 142. The information is used to determine if the fryer 124 is in an idle state or that it is not currently cooking product. Once this condition is met, the controls 132 activate the filter motor/pump assembly 108. The motor/pump assembly pumps the oil through the system as previously. If the filter controls 132 receive inputs from any of the input sensors 134, 136, 138, 140, and 142 that the fryer has fallen below the reasonable range of its set point in the idle mode and begun a cooking process, the controls 132, will automatically stop the motor/pump 108. Automatic filter operations will commence once the filter controls 132 receives information from the input sensors 134, 136, 138, 140, and 142 that the fryer 126 is again in the idle mode and has achieved the fryer temperature set point for some period of time.

FIG. 3 shows an exploded view of the filter cartridge components top ring insert 202, inner filter cartridge 204, filter media 206, outer filter cartridge 208, and bottom inner filter cartridge insert 210. The view further shows the outer filter cartridge housing 212. The inserts 202 and 210 hold the filter media 206 in place around the inner filter cartridge 204. The pressure of the oil within the system pushes the filter media 206 against the outer filter cartridge 208 allowing sediment to be captured between the filter media 206, and the inner filter cartridge 204.

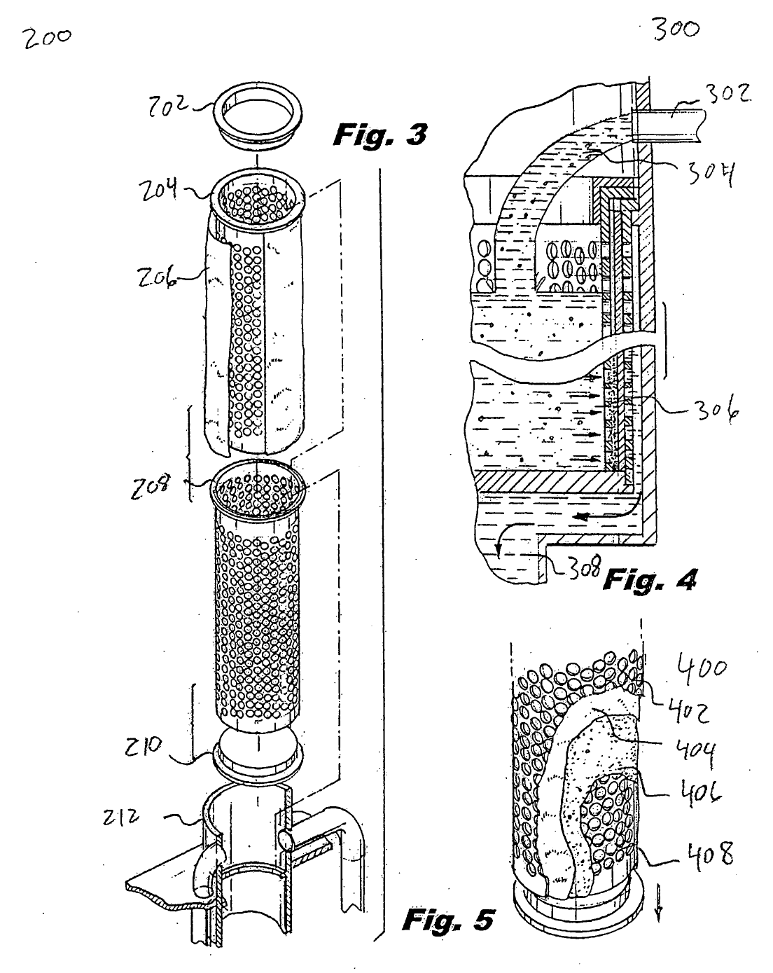

FIG. 4 shows the assembly 300 having an inlet pipe 302, an oil flow with sediment 304, oil flow through the filter media 306, and the exit of the clean oil out of the filter assembly 308. The contaminated oil enters the filter assembly 300 via the oil inlet pipe 302 and is forced under pressure through the filter canister assembly as previously described in FIG. 3. Sediment is trapped in the filter media 306 allowing clean oil to return back to the fryer via the exit of the filter assembly 308.

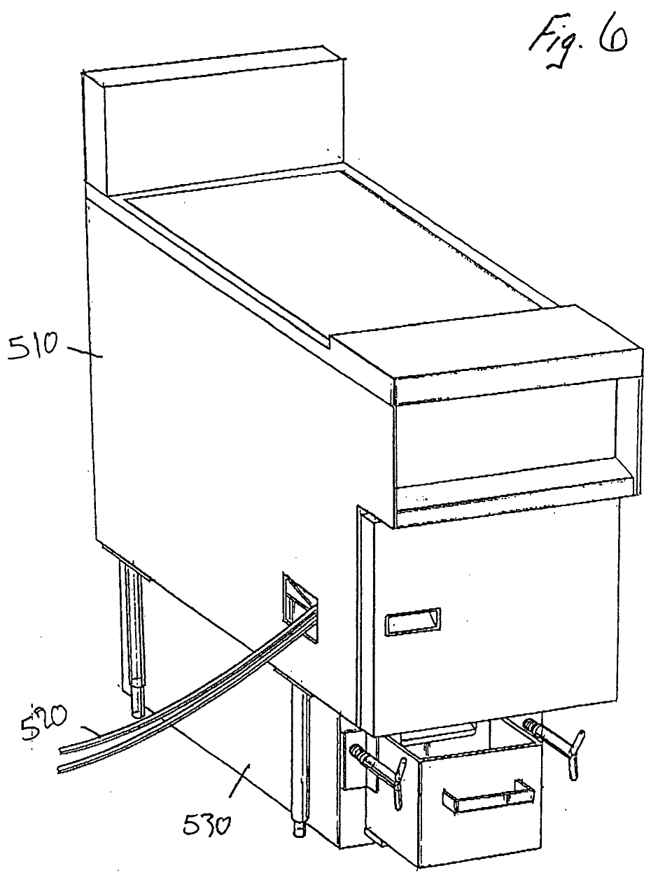

FIG. 5 shows as assembly 400 having a stainless steel mesh inner and outer filter components 402 and 408 respectively along with the filter media 404 and sediment build up 406.

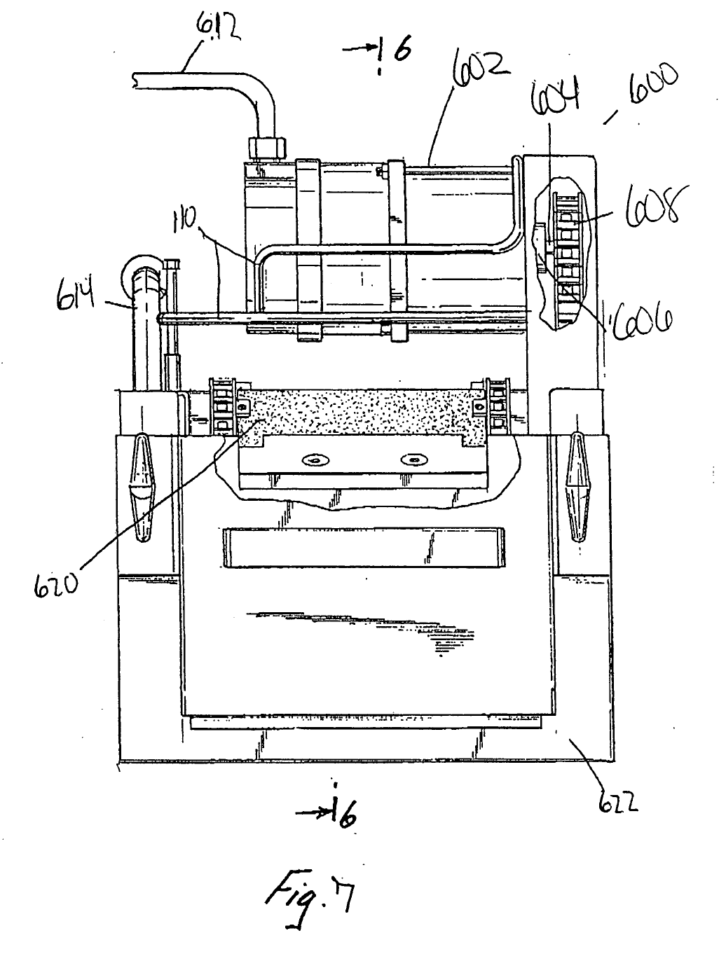

FIG. 6 shows the fryer 510 electrical cords 520 and filter assembly 530. The electrical cords 520 is capable of operations using different standard voltages found in a restaurant or supermarket deli. The electrical cords 520 can operate on 110V, 208V single phase, and 208V three phase. The filter assembly 530 is capable of being removed from under the fryer for cleaning and maintenance.

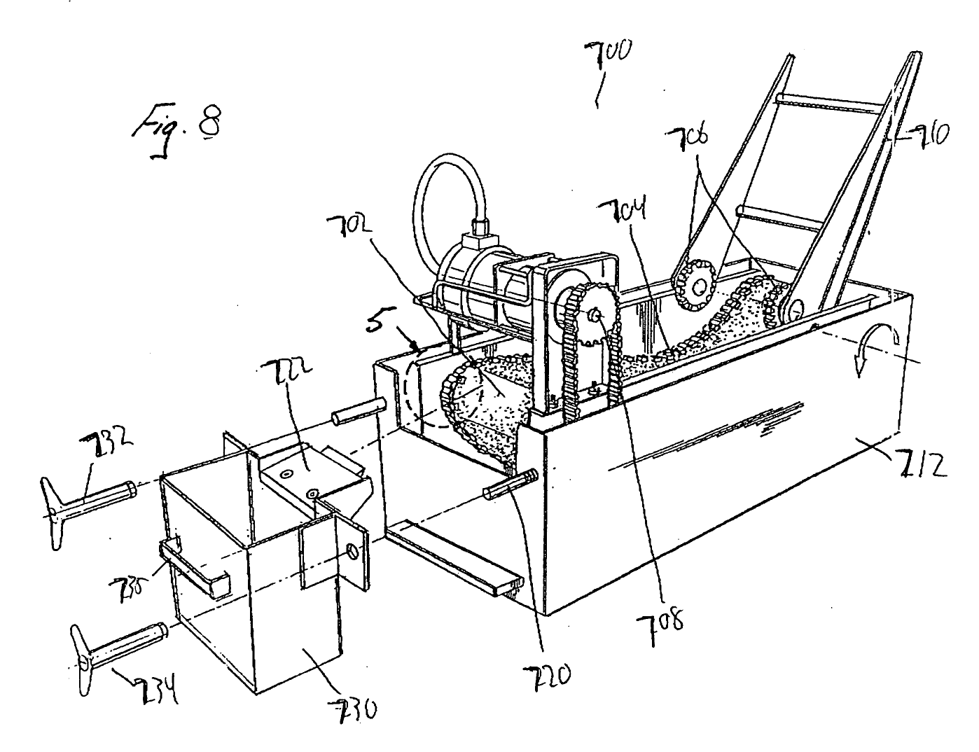

FIG. 7 shows the assembly 600 of the present invention which includes a filter belt drive motor 602 having a shaft 604 a bearing 606 and a drive chain and sprocket 608. The device 600 further comprises a motor support bracket 610 an electrical cord 612 and an oil suction line 614. The device 600 further has a filter crumb separation mesh belt 620 and a filter outer pan 622.

FIG. 8 shows a side view of the device 700 comprised of a filter belt 702 a filter belt drive chain 704, idler sprockets 706, drive sprocket 708 and a filter belt hold down 710. The device further comprises a filter outer pan 712. The device has a crumb tray tensioning spring 720 a filter belt scraper bar 722. The device further comprises a crumb tray 730 having a crumb tray handle 735 and crumb tray fasteners 732 and 734.

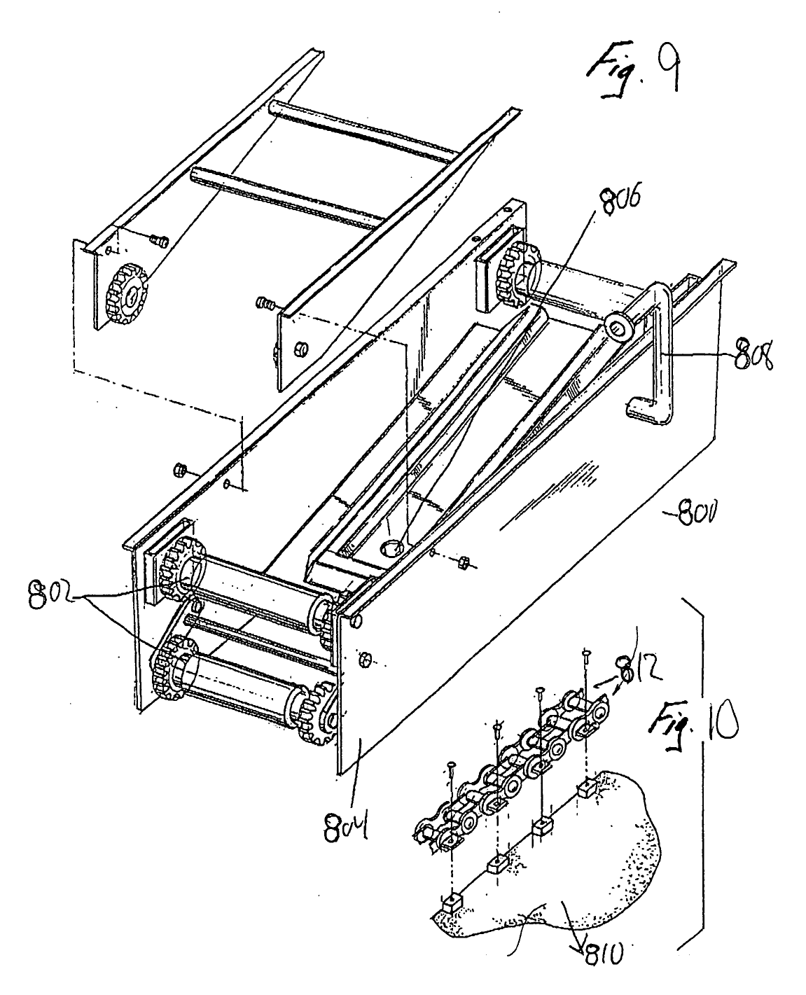

FIG. 9 shows the device 800 having filter belt idler rollers/sprockets 802 within a filter frame assembly 804. The device has an oil sump 806 and an oil suction line 808.

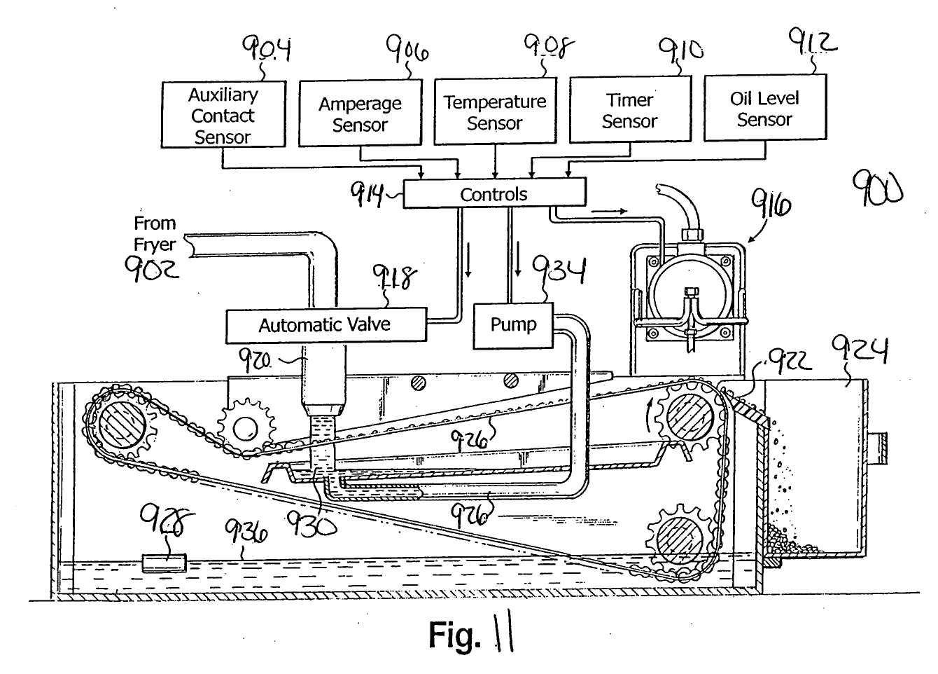

FIG. 10 shows the mesh belt 810 and the chain drive 812.

FIG. 11 shows the filter 900. The filter controls 914 have an off, manual and automatic mode setting. The off mode shuts the unit completely off and the manual mode allows the operator to initiate continuous filtration. In the automatic mode, the filter controller 914 receives inputs from filter sensors 904, 906, 908, 910, and 912. The information is used to determine if the fryer 902 is in an idle state or that it is not currently cooking product. Once this condition is met, the controls 914 activate the filter drive motor 916, filter pump 934, and opens the automatic valve 918. Once the valve 918 opens, the oil is gravity fed from the fryer 902 through the valve 418 and onto the filter belt 926 via the oil dispersion tube 920. The pump 934 creates suction pressure via the oil sump 932 across the filter belt 926. The crumb is sucked onto the belt 926 while the oil is pulled through the belt using the pump suction 934 and clean oil is returned to the fryer 902 via the oil return line 930. The belt 926 moves slowly up the incline using the belt drive motor, sprockets, and chain 916 in the direction of the crumb tray 924. The oil level is maintained 936 below the oil dispersion tube 920 by using the oil level float 928 which modulates the automatic valve open and closed 920 via the filter controls 914. The crumb is then removed from the filter belt 926 using a spring loaded scraper bar 922. The crumb drops into the crumb tray 924. The tray 924 can be removed from the device and the crumb can be discarded periodically. If the filter controls 914 receive inputs from any of the input sensors 904, 906, 908, or 910 that the fryer has fallen below the reasonable range of its set point in the idle mode and begun a cooking process, the controls 914, will automatically close the automatic valve 918, stop the pump 934, and stop the filter belt drive motor 916. Automatic filter operations 900 will commence once the filter controls 914 receives information from the input sensors 904, 906, 908, and 910 that the fryer 900 is again in the idle mode and has achieved the fryer temperature set point for some period of time.

1. An automatic oil filtration system for a commercial fryer comprising:
automatic filtration;
on demand filtration;
continuous oil level control;
heating of oil during filtering cycle and oil treatment.

2. The system of claim 1 wherein in said automatic filtration mode, filter controls sense oil temperature, heating element amperage, cooking timer, and an auxiliary contact from a fryer heating system and filters oil automatically when temperature of said fryer is stable and set point has been satisfied for a brief period of time.

3. The system of claim 2 wherein once triggered, automatic controls start a pump allowing hot oil to be pumped through stainless steel fine mesh screens with a paper and or cloth type filter medium.

4. The system of claim 1 further comprising filter containers comprising locking caps to contain the oil within said system.

5. The system of claim 4 wherein said filter containers are located adjacent to said fryer and at approximately same level as the fryer oil to allow said oil to maintain a level within normal operating limits both during product frying and filtering operations.

6. The system of claim 1 wherein sediment is deposited on a filter medium within tubes and is cleaned by replacing said filter medium and washing stainless steel inserts periodically.

7. The system of claim 6 wherein after passing through said filter medium, oil is directed via a port in rear of said fryer onto bottom of said fryer to move any accumulated sediment toward oil discharge area.

8. The system of claim 3 wherein if said oil temperature sensor in said fryer senses a high demand for heat, said filter shuts off said pump thus shutting off said filter system.

9. The system of claim 1 wherein said system can also be initiated by an operator after cooking a batch by pressing a manual cycle start button or by receiving a signal from a product cooking timer.

10. The system of claim 1 further comprising a built in timer that is set for a certain period of time and then automatically shuts off.

11. The system of claim 1 wherein said system continuously runs by placing said system in manual mode.

12. The system of claim 1 further comprising:
an automated dosing pump in a return pipe that injects additives or antioxidants into said oil.

13. The system of claim 12 wherein automatic controls log a record of amount of product that has been fried, so that amount of oil additive or antioxidant can be metered in an exact amount required by cooked product's consumption.

14. The system of claim 2 wherein said filter is mounted adjacent to said fryer or mounted remotely.

15. The system of claim 2 wherein said filter can filter multiple fryers either simultaneously or individually in sequence.

16. The system of claim 3 wherein said pump is mounted under each fryer and inputs are run to wherever the fryer filter is stationed.

17. The system of claim 3 wherein an output wirer is run from said filter controls to said pump to start and stop said pump.

18. The system of claim 2 wherein supply and return pipelines are run from said fryers to said remote filter.

19. The system of claim 1 wherein said filter can be programmed to filter fryers based on priorities set by an operator.

20. The system of claim 1 wherein said system sensors when said fryer is idle and automatically commences filtration.

21. The system of claim 1 wherein filter controls sense when a fryer begins to operate under load by sensing a falling temperature in a fryer well when product is added and automatically shuts off said filter making all heat available in said fryers available for cooking.

22. The system of claim 1 wherein an operator can initiate a timed filtration cycle, or said system can start a timed cycle by receiving an input signal from a product cook timer.

23. The system of claim 1 wherein said system maintains a consistent oil level within said fryer.

24. The system of claim 1 wherein said system maintains a constant oil level and a closed loop system so that said filter can be cycled automatically, on demand, and a fryer's heating system can continue to operate during filtration.

25. A device for automatic oil filtration for a commercial fryer comprising:
a motor/pump assembly;
closed loop filter canisters;
wherein oil that is contained in said fryer feeds said motor pump assembly via piping;
said motor pump assembly pumping dirty oil in said filter pump assemblies;
an oil return pipe; valves used for draining;
a filter controller.

26. The device of claim 25 wherein said canisters have removable lids.

27. The device of claim 25 further comprising a cycle start button.

28. The device of claim 26 wherein said lid engages a safety proximity switch for said motor/pump assembly to operate.

29. The device of claim 25 further comprising a pressure gauge showing the back pressure on said filter cartridge assemblies.

30. The device of claim 25 wherein said filter cartridge assemblies are sealed by removable caps.

31. The device of claim 25 further comprising a self venting line which allows any air or steam to vent out of said device automatically.

32. The device of claim 25 further comprising a thermocouple.

33. The device of claim 25 further comprising a filter control having an off, manual and automatic mode setting.

34. The device of claim 25 wherein said motor pump runs for a predetermined time and automatically shuts off.

35. The device of claim 25 wherein said filter controller receives inputs from filter sensors.

36. The device of claim 35 wherein once said filter controls receive inputs from any of said input sensors that said fryer has fallen below a reasonable range of its set point in an idle mode and begun a cooking process, said controls automatically stop said motor/pump.

37. The device of claim 36 wherein automatic filter operations commence once said filter controls receive information from said input sensors that said fryer is again in said idle mode and has achieved a fryer temperature set point for some period of time.

38. The system of claim 1 wherein pressure of said oil within said system pushes a filter media against an outer filter cartridge allowing sediment to be captured between said filter media, and an inner filter cartridge.

39. The device of claim 25 wherein said device is a mobile unit;
said motor/pump is mounted under said filter canisters and said device is attached to said fryer via a fryer drain valve.
